(19) United States
(12) Patent Application Publication
(10) Pub. No.: US 2014/0337554 A1
(43) Pub. Date: Nov. 13, 2014

(54) ELECTRONIC DEVICE AND UPDATING CIRCUIT THEREOF

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: YA-GUO WANG, Shenzhen (CN); CHUN-CHING CHEN, New Taipei (TW)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/273,537

(22) Filed: May 8, 2014

(30) Foreign Application Priority Data
May 10, 2013 (CN) 2013101698389

(51) Int. Cl. G06F 13/40

(52) U.S. Cl. CPC G06F 13/4068
USPC 710/300

(57) ABSTRACT

An electronic device includes a main chip, a storage, and a state changing unit. The main chip includes an update pin. The storage includes a write pin and an enable pin. The enable pin is connected to a programming unit. The main chip reads and writes data into the storage when the enable pin is at a first voltage level, and sets the update pin as a GPIO interface when the main chip is powered on after a predetermined time period. The state changing unit controls the enable pin to be at another voltage level within a second predetermined time period when the main chip is powered on and sets the enable pin at the first voltage level when the second predetermined time period elapses. The programming unit updates programs of the storage via the update pin and the write pin when the second predetermined time period elapses.

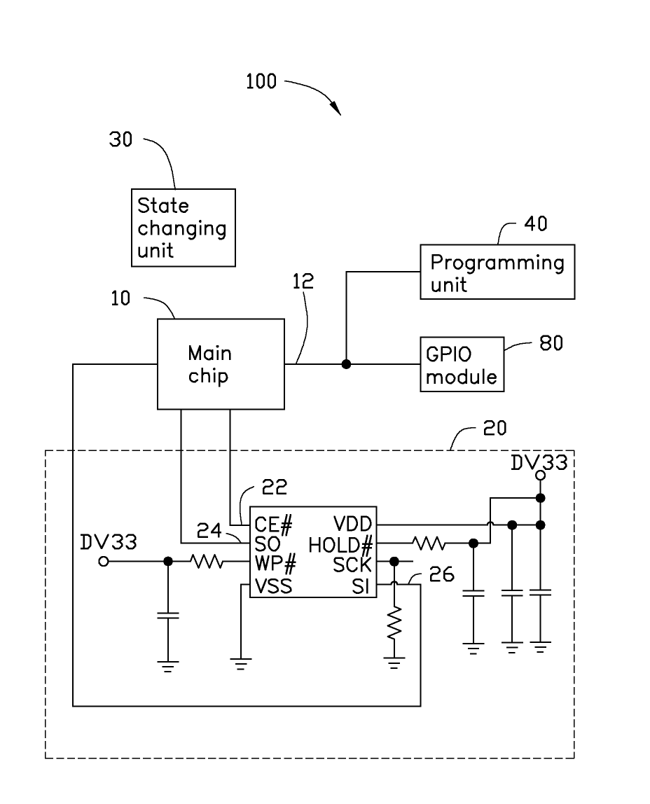

### FIELD

The present disclosure relates to an electronic device and an updating circuit thereof.

### BACKGROUND

An electronic device (e.g., a DVD player) includes a main chip. The main chip includes a plurality of general purpose input/output (GPIO) pins to connect to other components of the electronic device, and an update pin to update programs of a storage (e.g., a flash memory) of the electronic device using a programming unit. The programming unit can write programs into the storage of the electronic device via the update pin. When the programs are written into the storage, the update pin is set to work as a GPIO pin to connect to and control the other components.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

The FIGURE is a schematic diagram of an embodiment of an electronic device.

### DETAILED DESCRIPTION

The disclosure is illustrated by way of example and not by way of limitation in the FIGURES of the accompanying drawings in which like references indicate similar elements. It should be noted that references to “an” or “one” embodiment in this disclosure are not necessarily to the same embodiment, and such references mean “at least one.”

Reference will be made to the drawings to describe various embodiments.

The FIGURE illustrates a schematic diagram of an embodiment of an electronic device 100. The electronic device 100 includes a main chip 10, a storage 20, a state changing unit 30, a programming unit 40, and a general purpose input/output (GPIO) module 80. The main chip 10 includes an update pin 12. The storage 20 includes an enable pin 22, a read pin 24, and a write pin 26. In the embodiment, the update pin 12 includes a transmit data (TXD) pin and a receive data (RXD) pin. The storage 20 can be a flash memory. The electronic device 100 can be a DVD player, an audio player, or other similar device. The main chip 10 can be a moving picture experts group (MPEG) encoding chip, for example.

The main chip 10 is electrically connected to the read pin 24 and the write pin 26. When the enable pin 22 is at a first voltage level, the main chip 10 is capable of reading data from the storage 20 and writing data into the storage 20. When the enable pin 22 is at a second voltage level, the main chip 10 cannot read data from the storage 20 and cannot write data into the storage 20. In the embodiment, the first voltage level can be a logic-low level, and the second voltage level can be a logic-high level.

The main chip 10 is electrically connected to the enable pin 22. When the main chip 10 is powered on, the main chip 10 sets the enable pin 22 to the first voltage level. The main chip 10 is initialized within a first predetermined time period after the main chip 10 is powered on, and then sets the update pin 12 as a general purpose input/output (GPIO) pin to connect to and control the other components of the electronic device 100.

The update pin 12 is electrically connected to the programming unit 40. The state changing unit 30 controls the enable pin 22 to be not at the first voltage level during a second predetermined time period when the main chip 10 is powered on. The enable pin 12 is controlled by the state changing unit 30 to be at the first voltage level when the second predetermined time period elapses. In the embodiment, the second predetermined time period is longer than the first predetermined time period. The programming unit 40 can be used to update programs of the storage 20 via the update pin 12 and the write pin 26 after the main chip 10 has been initialized.

Since the second predetermined time period is longer than the first predetermined time period, the enable pin 22 is not at the first voltage level after the main chip 10 has been initialized. Thus, the main chip 10 cannot read the programs from the storage 20, and the programming unit 40 can be used to update the programs of the storage 20.

In detail, the state changing unit 30 first controls the enable pin 22 to electrically connect to the read pin 24, and then cuts off the electrical connection between the enable pin 22 and the read pin 24 after the second predetermined time period elapses. In the embodiment, the state changing unit 30 can be an electronic switch that includes a control terminal, a first conducting terminal, and a second conducting terminal. The first conducting terminal is electrically connected to the enable pin 22, and the second conducting terminal is electrically connected to the read pin 24. When the control terminal is operated within the second predetermined time period, the electronic switch controls the enable pin 22 to connect to the read pin 24.

In one embodiment, the state changing unit 30 first controls the enable pin 22 to electrically connect to the write pin 26 within the second predetermined time period, and then cuts off the electrical connection between the enable pin 22 and the write pin 26 after the second predetermined time period elapses.

In one embodiment, the state changing unit 30 first sets the enable pin 22 to be at the second voltage level within the second predetermined time period, and then sets the enable pin 22 to be at the first voltage level after the second predetermined time period elapses.

The update pin 12 is electrically connected to the GPIO module 80. When the update pin 12 is set as a GPIO pin, the main chip 10 can output GPIO signals to the GPIO module 80 to control the GPIO module 80 to perform predetermined functions. In the embodiment, the GPIO module 80 can be an audio amplifier. For example, when the audio amplifier receives a GPIO signal from the update pin 12, the audio amplifier is controlled to work in a mute state.

It is to be understood that even though numerous characteristics and advantages of the present embodiments have been set forth in the foregoing description, with details of the structures and functions of the embodiments, the disclosure is illustrative only; and changes may be in detail, especially in the matters of arrangement of parts within the principles of the embodiments to the full extent indicated by the broad general meaning of the terms in which the appended claims are expressed.

What is claimed is:

1. An electronic device, comprising:
a main chip comprising an update pin;
a storage comprising an enable pin connected to a programming unit, and a write pin; and
a state changing unit;
wherein:
the main chip reads data from the storage and writes data into the storage when the enable pin is at a first voltage level, and sets the update pin as a general purpose input/output (GPIO) interface when a first predetermined time period elapses after the main chip has been powered on;
the state changing unit controls the enable pin to be not in the first voltage level in a second predetermined time period when the main chip is powered on and controls the enable pin to be at the first voltage level after the second predetermined time period;
the programming unit updates the program of the storage via the update pin and the write pin after the second predetermined time period; and
the second predetermined time period is longer than the first predetermined time period.

2. The electronic device of claim 1, wherein the state changing unit controls the enable pin to electrically connect to a read pin, and cuts off the electrical connection between the enable pin and the read pin when the second predetermined time period elapses.

3. The electronic device of claim 1, wherein the state changing unit controls the enable pin to electrically connect to the write pin in the second predetermined time period, and cuts off the electrical connection between the enable pin and the write pin when the second predetermined time period elapses.

4. The electronic device of claim 1, wherein the state changing unit sets the enable pin to be at the second voltage level within the second predetermined time period, and sets the enable pin to be at the first voltage level when the second predetermined time period elapses.

5. The electronic device of claim 1, further comprising a GPIO module electrically connected to the update pin, and the main chip outputting GPIO signals to the GPIO module when the update pin is set to work as a GPIO pin.

6. The electronic device of claim 5, wherein the GPIO module is an audio amplifier works at a mute state when the GPIO signals are received from the update pin.

7. The electronic device of claim 1, wherein the storage is a flash memory.

8. The electronic device of claim 1, wherein the update pin comprises a transmit data (TXD) pin and a receive data (RXD) pin.

9. The electronic device of claim 1, wherein when the enable pin is in a second voltage level, the main chip is configured to read data from the storage and write data into the storage.

10. The electronic device of claim 1, wherein the first voltage level is a logic-low level, and the second voltage level is a logic-high level.
